(19) United States
(12) Patent Application Publication
(10) Pub. No.: US 2003/0235298 A1
(43) Pub. Date: Dec. 25, 2003

(54) Shifting an encryption key in either a first or second direction via a uni-directional shifting unit

(76) Inventor: Bedros Hanounik, Cupertino, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/179,862

(22) Filed: Jun. 25, 2002

(51) Int. Cl. H04K 1/00

(52) U.S. Cl. 380/29

(57) ABSTRACT

According to some embodiments, an encryption key is shifted in either a first or second direction via a uni-directional shifting unit.

### BACKGROUND

To protect and/or authenticate information, it is known that a sender can encrypt data. For example, the sender may encrypt an original message of “plaintext” to create “ciphertext,” such as by encrypting the plaintext using an encryption key in accordance with the Data Encryption Standard (DES) defined by American National Standards Institute (ANSI) X3.92 “American National Standard for Data Encryption Algorithm (DEA)” (1981). The sender can then securely transmit the ciphertext to a recipient. The recipient decrypts the ciphertext to re-create the original plaintext (e.g., using a decryption key in accordance with DES).

To increase the security of an encryption process, multiple rounds of encryption may be performed. Moreover, an encryption key may be modified between each round. For example, FIG. 1 is an overview of a DES encryption process 100 in which a function (ƒ) 110 is applied during each of sixteen rounds. The function 110 may include, for example, an exclusive OR (XOR) operation. For clarity, only some of the steps performed during a DES encryption process are described herein.

Note that a different encryption key is used for each round (i.e., K₁, K₂, . . . K₁₆). In particular, two halves of an original 56-bit encryption key are circularly shifted by either one or two bit positions during each round. Moreover, the keys are shifted to the left (by one or two bit positions) when data is encrypted and to the right (by one or two bit positions) when data is decrypted. FIG. 2 illustrates encryption key shifting during a DES encryption process. As shown in a table 200, each encryption round 202 is associated with a number of bits to circularly shift left or right 204. For example, when encrypting data the key is shifted to the left by one bit position in the ninth round. Similarly, when decrypting data the key is shifted to the right by two bit positions in the tenth round.

FIG. 3 illustrates an initial encryption key 310 comprised of bits b₀ through b₇ in bit positions P₀ through P₇. Note that an eight-bit encryption key is illustrated in FIG. 3 for clarity (although a 56-bit encryption key may actually be used during a DES encryption process). If the initial key 310 is circularly shifted to the left by two bit positions (e.g., when encrypting data), the resulting key 320 has bit b₀ in position P₂. If the initial key 310 is circularly shifted to the right by two bit positions (e.g., when decrypting data), the resulting key 330 has bit b₀ in position P₆.

Thus, a device adapted to protect and/or authenticate information may need to shift an encryption key by various numbers of bits (e.g., by one or two bit positions) in either direction. This type of device, however, may be inefficiently designed given the environment in which it is implemented. For example, a device may be designed for a Field-Programmable Gate Array (FPGA) environment. An FPGA is an integrated circuit that can be programmed after manufacture by connecting various Configurable Logic Blocks (CLBs), such as look-up tables, together in different ways. A design for a device adapted to protect and/or authenticate information might inefficiently use such CLBs, especially if different types of processes need to be supported (e.g., shifting an encryption key to the left or right by one or two bit positions). For example, a bi-directional shifting unit, or both a left shifting unit and a right shifting unit, might occupy a inefficient amount of area in an encryption device.

### BRIEF DESCRIPTION OF THE DRAWINGS

FIG. 1 is an overview of a DES encryption process.

FIGS. 2 and 3 illustrate encryption key shifting during a DES encryption process.

FIG. 4 is a flow chart of a method of facilitating an encryption process according to some embodiments.

FIG. 5 is a block diagram of an encryption device according to some embodiments.

FIG. 6 illustrates encryption key shifting according to some embodiments.

FIG. 7 illustrates a bit reversing unit according to some embodiments.

FIG. 8 is a block diagram of a uni-directional shifting unit and a number of bit reversing units according to some embodiments.

FIG. 9 is a flow chart of a method of facilitating an encryption process according to some embodiments.

### DETAILED DESCRIPTION

Some of the described embodiments are associated with an “encryption process.” As used herein, the phrase “encryption process” may refer to a process that encrypts or decrypts data. Examples of an encryption process include DES, triple-DES as defined by ANSI X9.52 “Triple Data Encryption Algorithm Modes of Operation” (1998), and Advanced Encryption Standard (AES) as defined by Federal Information Processing Standards (FIPS) publication 197 (2002). Details about these, and other, encryption processes can be found in Bruce Schneier, “Applied Cryptography” (2nd Ed., 1996).

### Encryption Method

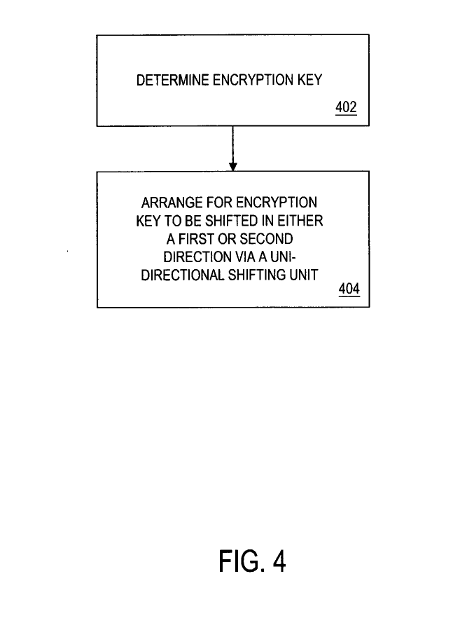

FIG. 4 is a flow chart of a method of facilitating an encryption process according to some embodiments. The method may be performed, for example, by an encryption device, such as an encryption engine. The flow charts in FIG. 4 and the other figures described herein do not imply a fixed order to the steps, and embodiments can be practiced in any order that is practicable.

At 402, an encryption key is determined. For example, two halves of a 56-bit DES encryption key may be received or retrieved from memory.

It is then arranged for the encryption key to be shifted in either a first or second direction via a uni-directional shifting unit at 404. As used herein, the phrase “uni-directional shifting unit” may refer to a device adapted to shift a series of bits in a single direction. By way of example, the encryption key may be shifted to the left when an encryption engine is encrypting data and to the right when the encryption engine is decrypting data.

### Encryption Device

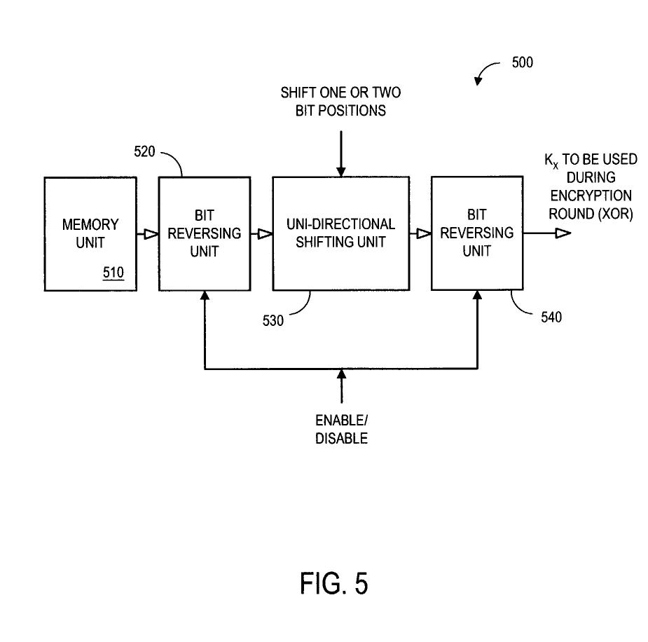

FIG. 5 is a block diagram of an encryption device 500 that may perform the method of FIG. 4 according to some embodiments. In particular, the encryption device 500 includes a memory unit 510 that stores an encryption key. Note that the encryption key stored in the memory unit 510 may comprise an original encryption key or an encryption key that has been used in a previous round of an encryption process (e.g., Kₓ₋₁).

A first bit reversing unit 520 is adapted to receive the encryption key from the memory unit 510. Moreover, the first bit reversing unit 520 receives an “Enable/Disable” signal. The “Enable/Disable” signal can be used to disable the unit 520 when the encryption key is shifted in one direction and to enable the unit 520 when the key is shifted in the other direction. According to some embodiments, the first bit reversing unit 520 is adapted to be used by a number of different encryption engines (e.g., four encryption engines may share a singe unit 520).

According to another embodiment, the first bit reversing unit 520 is implemented via a software application. For example, the software application may store an encryption key in the memory unit 510 when the key is to be shifted in a first direction and a reversed key in the memory unit 510 when the key is to be shifted in the other direction.

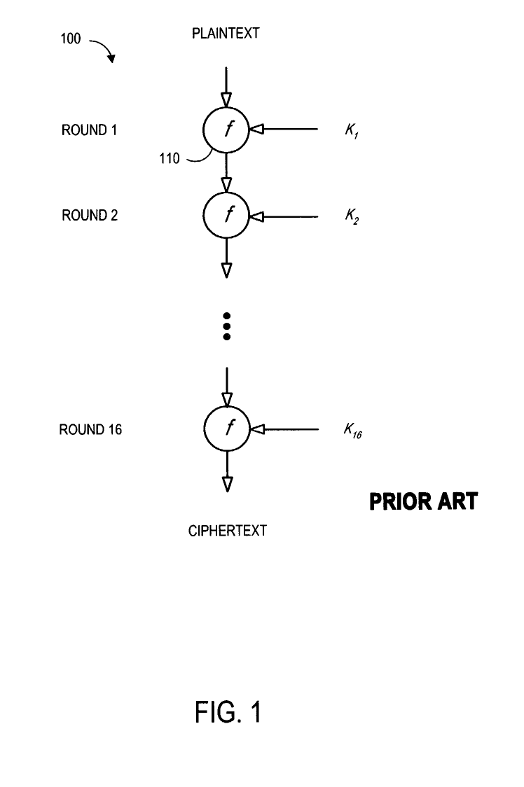

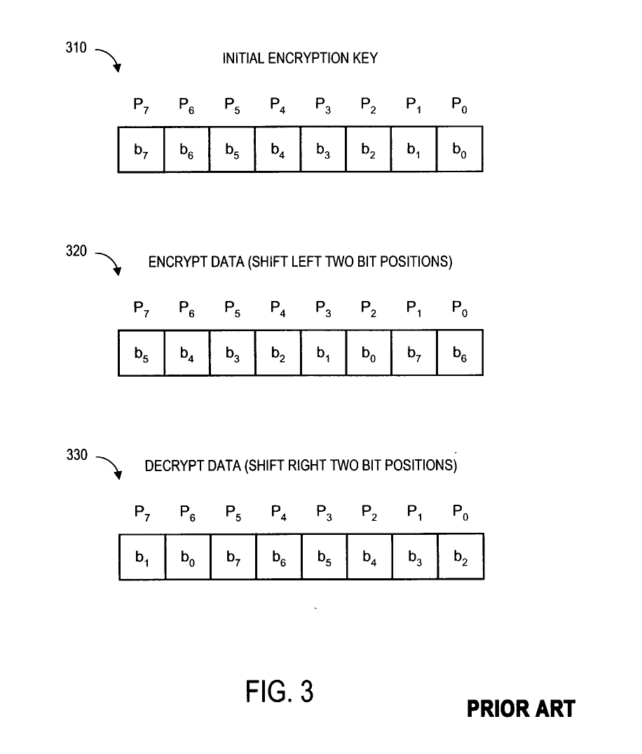

A uni-directional shifting unit 530 is adapted to receive information from the first bit reversing unit 520. For example, the uni-directional shifting unit 530 may be adapted to circularly shift information to the left (but not to the right). According to some embodiments, the uni-directional shifting unit 520 is further adapted to shift information either (i) a first number of bit positions or (ii) a second number of bit positions. For example, the uni-directional shifting unit 520 might receive a signal indicating whether information should be circularly shifted to the left by either one or two bit positions. Note that the number of bit positions being shifted may be based on the encryption round being performed (e.g., as described with respect to FIGS. 1 through 3).

A second bit reversing unit 540 is adapted to receive information from the uni-directional shifting unit 530. Moreover, the second bit reversing unit 540 receives an “Enable/Disable” signal that can be used to disable the unit 540 when the encryption key is shifted in one direction and to enable the unit 540 when the key is shifted in the other direction. The second bit reversing unit 540 is further adapted to provide information (e.g., Kₓ) to be used in an encryption process (e.g., a process that includes an XOR operation).

Consider now the case where the uni-directional shifting unit 530 is adapted to circularly shift information to the left by one or two bit positions during a DES encryption process. If data is being encrypted (i.e., the encryption key needs to be shifted to the left), the first and second bit reversing units 520, 540 are disabled. As a result, the encryption key simply passes from the memory unit 510 to the uni-directional shifting unit 530 which shifts the information to the left an appropriate number of bits. The result may then be used during an encryption process.

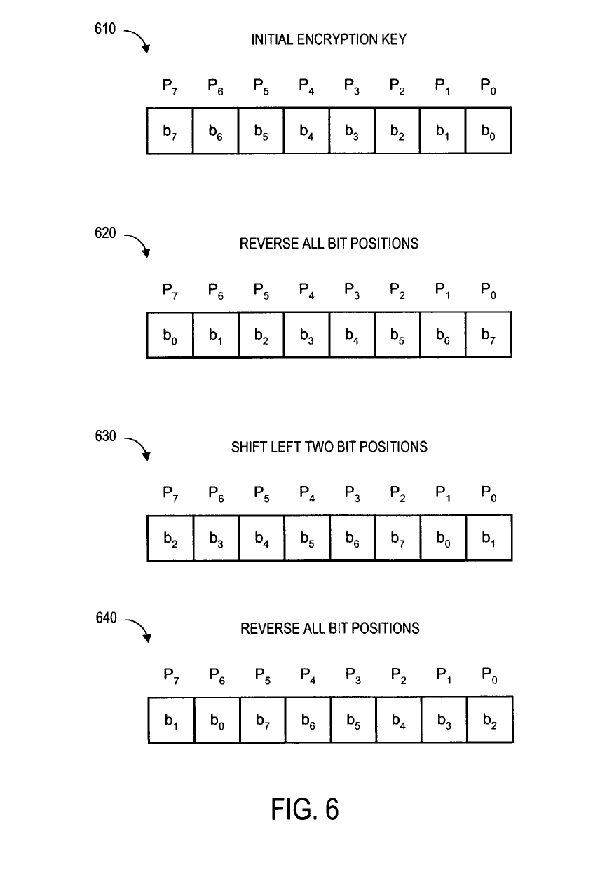

If data is being decrypted, however, the encryption key needs to be shifted to the right. In this case, the first bit reversing unit 520 is enabled. As a result, as illustrated in FIG. 6 (note that an eight-bit encryption key is illustrated in FIG. 6 for clarity) an initial encryption key 610 is converted into a reversed series of bits 620. That is, the information b₀ that was in the Least Significant Bit (LSB) position (P₀) is now in the Most Significant Bit (MSB) position (P₇). The uni-directional shifting unit 530 then shifts the reversed series of bits 620 to the left (e.g., by two bit positions) to generate a result 630. The second bit reversing unit 540 is also enabled, and therefore this result 630 is reversed to generate Kₓ that can be used during an encryption process.

Note that reversing the initial key 610, circularly shifting the bits to the left by two bit positions, and reversing the result produces the same outcome as circularly shifting the initial key 610 to the right by two bit positions (e.g., b₀ ends up in P₆). This will be true regardless of the number of bit positions being shifted by the uni-directional shifting unit 530.

Also note that a similar process may be used if the uni-directional shifting unit 530 is adapted to only circularly shift information to the right (instead of to the left). In this case, the first and second bit reversing units 520, 540 may be enabled when encrypting data and disabled when decrypting data.

Thus, a single, uni-directional shifting unit 530 may be used to shift an encryption key in either a first or second direction. As a result, the use of a bi-directional shifting unit, or both a left shifting unit and a right shifting unit, may be avoided—reducing the amount of area required, for example, by an encryption engine.

### EXAMPLE

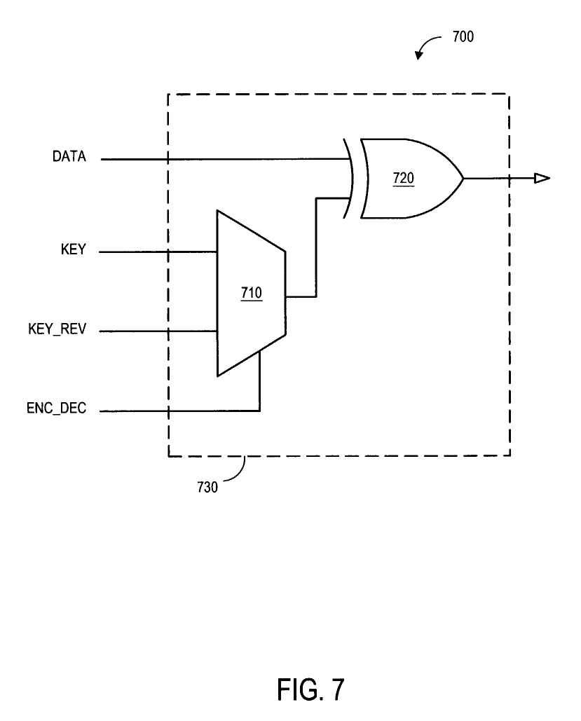

FIG. 7 illustrates a bit reversing unit 700 according to some embodiments. This bit reversing unit 700 may be associated with, for example, a single bit position in the second bit reversing unit 540 described with respect to FIG. 5.

Recall that the information provided by the second bit reversing unit 540 may be provided to an encryption process, such as encryption process that combines the information with data (e.g., data that is being encrypted or decrypted) via an XOR operation. The bit reversing unit 700 illustrated in FIG. 7 performs this function in addition to (optionally) reversing information generated by the uni-directional shifting unit 530.

In particular, the bit shifting unit 700 includes a multiplexer 710 that receives a “Key” signal that represents one bit of information generated by the uni-directional shifting unit 530. The multiplexer 710 also receives a “Key_Rev” signal that represents one bit of the reverse of information generated by the uni-directional shifting unit 530.

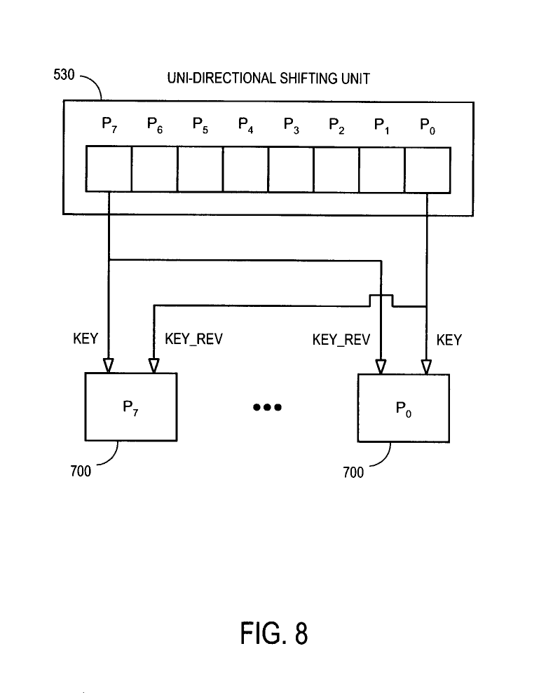

For example, FIG. 8 is a block diagram of the uni-directional shifting unit 530 and a number of bit reversing units 700 (e.g., each associated with a single bit position) according to some embodiments. Once again, the device illustrated in FIG. 8 has only eight-bit positions for clarity. Note that the bit reversing unit 700 associated with P₀ receives the “Key” signal from P₀ in uni-directional shifting unit 530 and the “Key_Rev” signal from P₇ in uni-directional shifting unit 530. Similarly, the bit reversing unit 700 associated with P₁ (not shown in FIG. 8) would receive the “Key” signal from P₁ in uni-directional shifting unit 530 and the “Key_Rev” signal from P₆ in uni-directional shifting unit 530.

Referring again to FIG. 7, the multiplexer 710 is controlled by a “Enc_Dec” signal. For example, when encrypting data the “Enc_Dec” signal may cause the multiplexer 710 to output the “Key” signal (i.e., the bit reversing unit 700 is disabled and the shifted encryption key provided by the uni-directional shifting unit 530 is not reversed). Similarly, when decrypting data the “Enc_Dec” signal may cause the multiplexer 710 to output the “Key_Rev” signal (i.e., the bit reversing unit 700 is enabled and the shifted encryption key provided by the uni-directional shifting unit 530 is reversed).

The output of the multiplexer 710 is provided to an XOR unit 720 that also receives a bit of “Data” (e.g., data that is being encrypted or decrypted during an encryption process). That is, the bit reversing unit 700 performs the XOR operation in addition to reversing (or not reversing) the information provided by the uni-directional shifting unit 530.

According to some embodiments, an encryption device is implemented in an FPGA environment. One example of an FPGA environment that may be appropriate for such an implementation is available from XILINX®. In this case, the bit reversing unit 700 may use a single slice of an FPGA for each bit of an encryption key. Moreover, because the bit reversing unit 700 receives four input lines (i.e., “Data,” “Key,” “Key_Rev,” and “Enc_Dec”), it may be implemented using a single FPGA Look-Up Table (LUT) 730. Using a single LUT 730 may reduce the area of the circuit and improve the performance of an encryption engine. According to other embodiments, an encryption device is instead implemented in an Application Specific Integrated Circuit (ASIC) environment.

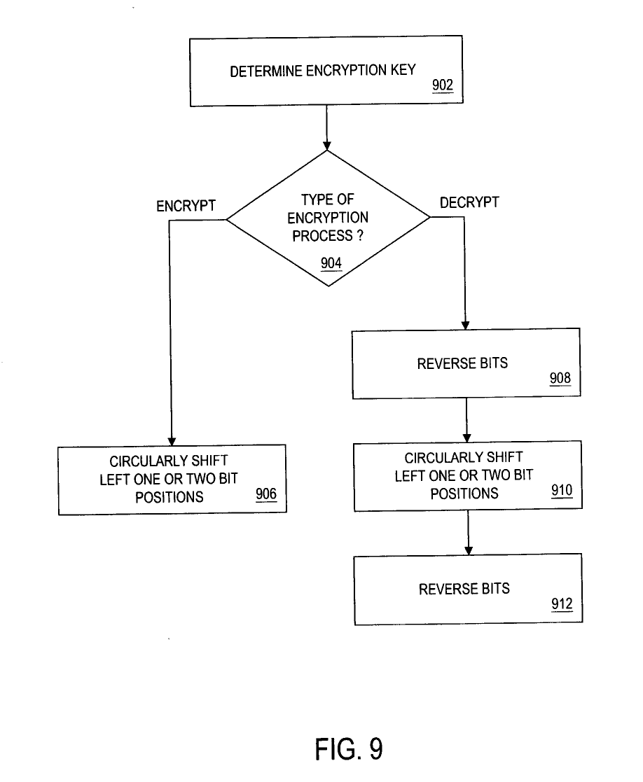

FIG. 9 is a flow chart of a method of facilitating an encryption process according to some embodiments. The method may be performed, for example, using any of the encryption devices illustrated in FIGS. 5, 7 and/or 8. Note that the method illustrated in FIG. 9 is associated with a DES encryption process and a uni-directional shifting unit 530 that is adapted to circularly shift bits to the left.

At 902, an encryption key is determined. For example, two halves of a 56-bit DES encryption key may be received or retrieved from the memory unit 510. Note that the encryption key determined at 902 may comprise an original encryption key or an encryption key that has been used in a previous round of an encryption process (e.g., Kₓ₋₁).

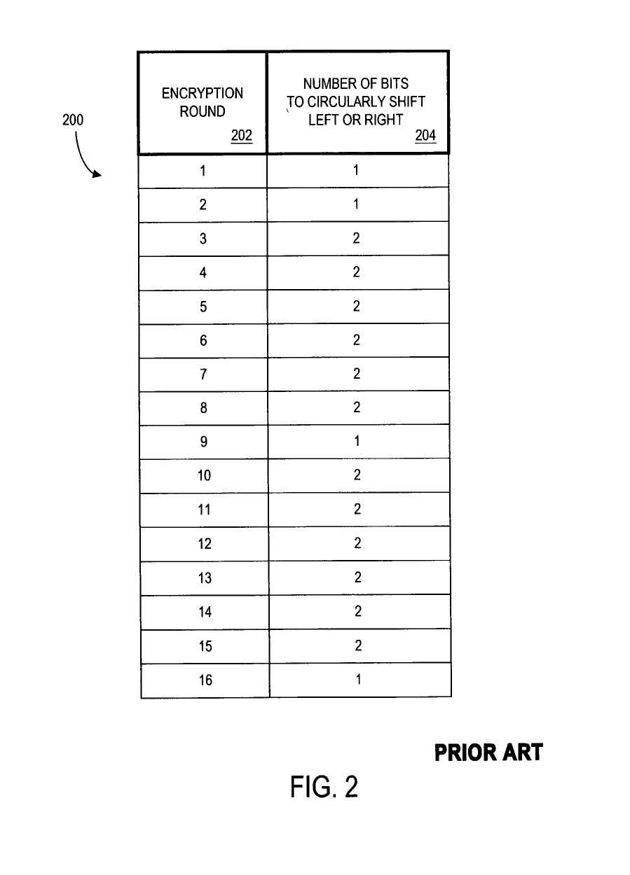

The type of encryption process being performed is then determined at 904. If data is being encrypted, the encryption key bits are circularly shifted to the left by one or two bit positions as appropriate at 906 (e.g., in accordance with FIG. 2). In other words, the first and second bit reversing units 520, 540 may be disabled causing the uni-directional shifting unit 530 to simply shift the key to the left to generate Kₓ—which may then be used during the current encryption round (e.g., Kₓ may be combined via an XOR operation with data that is being encrypted).

If it is determined that data is being decrypted at 904, the first bit reversing unit 520 may be enabled. As a result, the bits in the encryption key are reversed at 908. The reversed encryption key bits are then circularly shifted to the left by one or two bit positions as appropriate at 910 by the uni-directional shifting unit 530 (e.g., in accordance with FIG. 2). The second bit reversing unit 540 may also be enabled, causing the information generated by the uni-directional shifting unit 530 to be reversed at 912. This information will represent Kₓ—which may then be used during the current encryption round (e.g., Kₓ may be combined via an XOR operation with data that is being decrypted).

### Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although embodiments have been described with respect to a DES encryption process, other embodiments may be associated with other types of encryption processes. Moreover, although software or hardware are described as performing certain functions, such functions may be performed using software, hardware, or a combination of software and hardware (e.g., a medium may store instructions adapted to be executed by a processor to perform a method of facilitating an encryption process). For example, functions described herein may be implemented via a software simulation of FPGA hardware.

The several embodiments described herein are solely for the purpose of illustration. Persons skilled in the art will recognize from this description other embodiments may be practiced with modifications and alterations limited only by the claims.

What is claimed is:

1. An encryption device, comprising:
a first bit reversing unit adapted to receive an encryption key;
a uni-directional shifting unit adapted to receive information from the first bit reversing unit; and
a second bit reversing unit adapted to receive information from the uni-directional shifting unit.

2. The encryption device of claim 1, wherein the first and second bit reversing units can be disabled when the encryption key is shifted in a first direction and enabled when the encryption key is shifted in a second direction.

3. The encryption device of claim 2, wherein the encryption key is circularly shifted left when encrypting information and right when decrypting information.

4. The encryption device of claim 1, wherein the encryption device is implemented via at least one of: (i) a field-programmable gate array, and (ii) an application specific integrated circuit.

5. The encryption device of claim 1, wherein the first bit reversing unit is adapted to receive the encryption key from a memory unit.

6. The encryption device of claim 1, wherein the first bit reversing unit is adapted to be used by a plurality of encryption engines.

7. The encryption device of claim 1, wherein the first bit reversing unit comprises a software application.

8. The encryption device of claim 1, wherein the uni-directional shifting unit is adapted to shift information either (i) a first number of bit positions or (ii) a second number of bit positions.

9. The encryption device of claim 8, wherein said encryption device is adapted to facilitate a multi-round encryption process, and the number of bit positions being shifted is based on the encryption round.

10. The encryption device of claim 1, wherein the second bit reversing unit is adapted to provide information to be used in an encryption process.

11. The encryption device of claim 10, wherein the encryption process includes an exclusive OR operation.

12. The encryption device of claim 11, wherein the second bit reversing unit comprises:
a multiplexer adapted to output one of a shifted encryption key bit and a reversed shifted encryption key bit based on a encrypt/decrypt control signal; and
an exclusive OR unit adapted to receive data and the output from the multiplexer.

13. The encryption device of claim 12, wherein the second bit reversing unit uses a single slice of a field-programmable gate array for each bit of an encryption key.

14. The encryption device of claim 13, wherein the second bit reversing unit comprises a look-up table.

15. The encryption device of claim 1, wherein the encryption device is associated with at least one of: (i) generating a ciphertext output based on a plaintext input and an encryption key, (ii) generating a plaintext output based on a ciphertext input and a decryption key, (iii) a data encryption standard process, (iv) a triple data encryption standard process, and (v) an advanced encryption standard process.

16. An encryption device, comprising:
a uni-directional shifting unit; and
a bit reversing unit adapted to receive information from the uni-directional shifting unit.

17. The encryption device of claim 16, wherein the bit reversing unit uses a single slice of a field-programmable gate array for each bit of an encryption key and comprises:
a multiplexer adapted to output one of a shifted encryption key bit and a reversed shifted encryption key bit based on a encrypt/decrypt control signal; and
an exclusive OR unit adapted to receive data and the output from the multiplexer.

18. A method of facilitating an encryption process, comprising:
determining an encryption key; and
arranging for the encryption key to be shifted in either a first or a second direction via a uni-directional shifting unit.

19. The method of claim 18, wherein said arranging comprises:
if the encryption key is shifted in the first direction:
shifting bits in the encryption key via the uni-directional shifting unit; and
if the encryption key is shifted in the second direction:
reversing bits in an encryption key,
shifting the reversed bits via the uni-directional shifting unit, and
reversing the shifted bits.

20. A medium storing instructions adapted to be executed by a processor to perform a method of facilitating an encryption process, the method comprising:
determining an encryption key; and
arranging for the encryption key to be shifted in either a first or a second direction via a uni-directional shifting unit.

21. The medium of claim 20, wherein said arranging comprises:
if the encryption key is shifted in the first direction:
shifting bits in the encryption key via the uni-directional shifting unit; and
if the encryption key is shifted in the second direction:
reversing bits in an encryption key,
shifting the reversed bits via the uni-directional shifting unit, and
reversing the shifted bits.
